(19) United States
(12) Patent Application Publication
(10) Pub. No.: US 2007/0165397 A1
(43) Pub. Date: Jul. 19, 2007

(54) Seasonal yard decoration

(76) Inventor: William Niskanen, Minneapolis, MN (US)

Correspondence Address: Steven Thrasher, 391 Sandhill Dr., Richardson, TX, 75080, US

(21) Appl. No.: 11/655,615

(22) Filed: Jan. 18, 2007

Related U.S. Application Data
(60) Provisional application No. 60/760,030, filed on Jan. 18, 2006.

(51) Int. Cl. F21S 8/00

(52) U.S. Cl. 362/145

(57) ABSTRACT

A seasonal yard decoration having a front surface, a back surface, and a bottom surface where each surface is a light-blocking material, the front surface has an ornamental display, the bottom surface has a first cut for receiving a light-generating device and a first via for receiving a steak, and a light-generating device coupled through the first cut such that when the light generating device generates light the plurality of cuts channel light from an interior portion of the device to an exterior portion of the device. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### CROSS-REFERENCE TO RELATED APPLICATION

The present application is related to and claims priority from pending U.S. Provisional Patent Application No. 60/760,030 to Niskanen entitled Seasonal Yard Decoration, filed 18 Jan. 2006.

### TECHNICAL FIELD OF THE INVENTION

The present invention is related to the field of yard decorations, and in particular to illuminated yard decorations.

### STATEMENT OF A PROBLEM ADDRESSED BY THE INVENTION

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### Discussion

Each year, persons spend billions on yard decorations for various events, such as holidays. Often, these devices are illuminated. It takes hours to mount and set up these devices, and they are often too bulky to store for the next season. The invention overcomes the disadvantages of these devices.

### BRIEF DESCRIPTION OF THE DRAWINGS

Various aspects of the invention, as well as an embodiment, are better understood by reference to the following detailed description. To better understand the invention, the detailed description should be read in conjunction with the drawings, in which like numerals represent like elements unless otherwise stated.

FIG. 1 illustrates a housing of the invention, comprising a front surface, a back surface, and a bottom surface;

FIG. 2 shows a light-generating device; and

FIG. 3 shows a front view of the invention.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for -functioning-” or “step for -functioning-” in the Claims section. Sixth, the invention is also described in view of the Festo decisions, and, in that regard, the claims and the invention incorporate equivalents known, unknown, foreseeable, and unforeseeable. Seventh, the language and each word used in the invention should be given the ordinary interpretation of the language and the word, unless indicated otherwise.

Of course, the foregoing discussions and definitions are provided for clarification purposes and are not limiting. Words and phrases are to be given their ordinary plain meaning unless indicated otherwise.

### Description of the Drawings

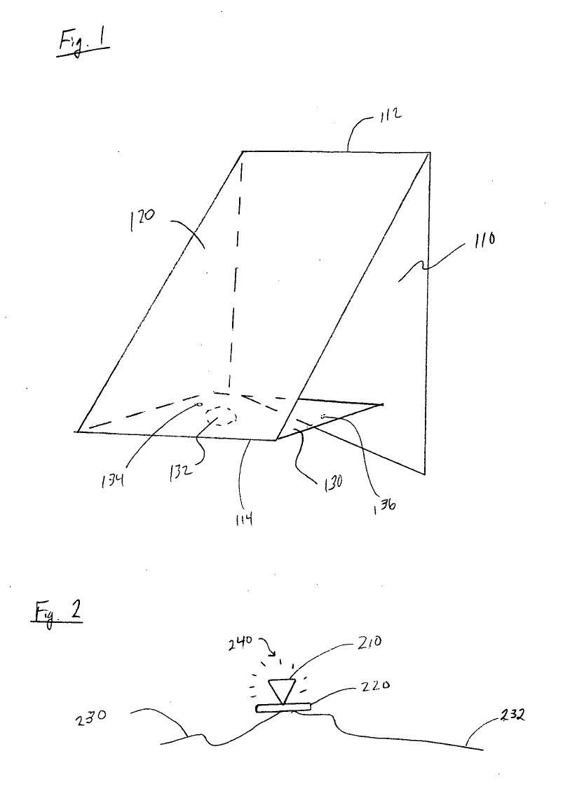

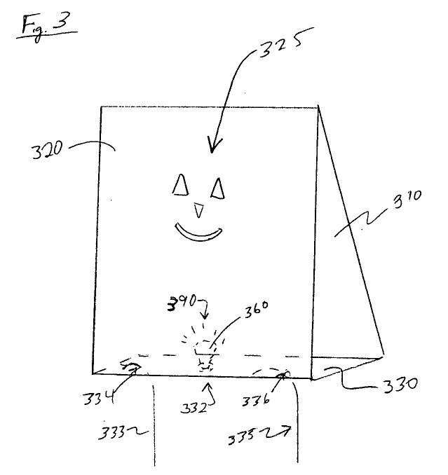

This discussion makes simultaneous reference to FIGS. 1, 2, and 3 in which FIG. I illustrates a housing of the invention, comprising a front surface, a back surface, and a bottom surface, FIG. 2 shows a light-generating device, and FIG. 3 shows a front view of the invention. The invention is a seasonal yard decoration. The invention includes a front surface 120, a back surface 110, and a bottom surface 130 which may be constructed of lightweight material, such as corrugated styrene sign material, corrugated cardboard, cardboard, plastic, or other materials. This material is in one embodiment opaque or light-resistant, waterproof, lightweight, and acts as its own hinge, and die cuts easily. Accordingly in one embodiment, the front surface 120 and back surface 110 couple to the bottom surface 130. Each luminary is in one embodiment made in one single unified piece, folded and may be shipped flat such that a first fold 112 exist between the back surface and the front surface 120, and a second fold 114 exist between the front surface 120 and the bottom surface 130. A first cut 132 is provided for providing a light generating device therethrough. Similarly, a first via 134 and a second via 136 are provided so that a steak may be inserted through either the first via 134 or the second via 136.

In one embodiment varying designs are offered in the display unit in which they where shipped. For example, the front surface 120 may comprise a plurality of cuts 325, the cuts 325 generating an ornamental display (generally 325) such as a jack-o-lantern, Christmas tree, jingle bell, witch, cat, dog, mouse, face, snow flake, flag, or heart, for example. When compressed, each unit is preferably rectangular and about ¾″ thick, 29″ tall, and 14″ wide, each piece being rectangular. Of course, it is understood that the surfaces may be any shape, and that rectangularity merely represents a preference. When packaged, each item includes a light-generating device (fugure 2) such as an LED 210 (Light Emitting Diode) or filament attachable to the bottom surface 130 via a mount 220, and is preferably a UL-approved socket and bulb (which, for example, is common to most light-up pumpkins), and a yard stake. Generally, a first wire 230 couples to the LED 210 which is also couples to a second wire 232 to complete a circuit and produce a light 240 when a current flows therethrough.

In one embodiment, once in a yard or in the home, the customer finds that once the device is relieved of its wrap-around label, it almost deploys itself. All that remains is to make the unit “rigid” by coupling the bottom surface 130 to the back surface 110, such as by locking tabs together (in one version) or lining up the holes in the bottom surface 130, and then driving stake(s) through the bottom surface 130 and into turf (not shown, but readily understood by one of ordinary skill in the art), anchoring the luminary device 360 as well as locking the device. One version has a stake 335 pulling double duty by being also the mount for the socket. The inside surfaces are preferably painted white to add to the dramatic effect of the silhouette.

Accordingly, the device includes a back 310, a front 320 and a bottom 330 having a cut 332 for accepting a light source 360 that produces light 390. Vias 334 and 336 accept steaks 333 and 335 to secure the device to a surface. An ornamental face 325, typically comprising cuts is provided to enhance the viewer experience.

### Light Diffusing Novelty Lamp—A Home Version.

One may play with a fan speed—and thus the wave effect—via the dial on the side. Preferably, this lamp uses components that are common—a 12V CPU cooling fan and a halogen reflector bulb. The whole thing stays cool and safe, without dangerous, scary, hot liquid.

This flowing ribbon-in-a-tube technique is conducive to going up or down in scale: in addition to a small, battery-powered pumpkin lamp, it can also be huge—imagine a 12″ diameter tube, running floor to ceiling, installed in a nightclub or in a stylish apartment.

Though the invention has been described with respect to a specific preferred embodiment, many variations and modifications (including equivalents) will become apparent to those skilled in the art upon reading the present application. It is therefore the intention that the appended claims and their equivalents be interpreted as broadly as possible in view of the prior art to include all such variations and modifications.

I claim:

1. A device, comprising:
a front surface, a back surface, and a bottom surface;
the front surface and the back surface being coupled to the bottom surface;
each surface being light-blocking;
the front surface comprising a plurality of cuts, the plurality of cuts comprising an ornamental display;
the bottom surface comprising a first cut for receiving a light-generating device;
the bottom surface comprising a first via for receiving a steak;
a light-generating device coupled through the first cut such that when the light generating device generates light the plurality of cuts channel light from an interior portion of the device to an exterior portion of the device.

2. The device of claim 1 wherein the light generating device comprises a diode.

3. The device of claim 1 further comprising a steak coupled through the device via.

4. The device of claim 1 wherein the bottom surface comprises a coupling that couples the bottom surface to the back surface.

5. The device of claim 1 wherein the front surface, the back surface, and the bottom surface are formed of a single piece of material.

6. The device of claim 1 wherein the front surface, the back surface, and the bottom surface are comprised of corrugated plastic.

7. The device of claim 1 wherein the front surface, the back surface, and the bottom surface are comprised of corrugated cardboard.

8. The device of claim 1 wherein the light generating device comprises a filament.

9. The device of claim 1 wherein the front surface, the back surface, and the bottom surface are substantially rectangular.

10. The device of claim 1 wherein the ornamental display is a jack-o-lantern.
